(19) United States
(12) Patent Application Publication
(10) Pub. No.: US 2005/0033798 A1
(43) Pub. Date: Feb. 10, 2005

(54) System comprising inow™ harmonizer for updating network communications, validation and data transfer

(76) Inventors: Mario Ruiz, Quito (EC); Victor Mejia, Quito (EC)

Correspondence Address: RASHIDA A. KARMALI, 99 WALL STREET, 13TH FLOOR, NEW YORK, NY, 10005, US

(21) Appl. No.: 10/637,682

(22) Filed: Aug. 8, 2003

(51) Int. Cl. G06F 15/16

(52) U.S. Cl. 709/200

(57) ABSTRACT

A middleware product suitable for retrofitting to an existing network environment to perform the functions of data synchronization, transfer and validation while providing a secondary channel to remove workload from the primary database thereby performing the functions of middleware without its associated disadvantages, for example, cost and labor intensive maintenance. The unique feature of this technology is a network-based data communication, validation, and transfer system known as the Harmonizer™, which is employed to interface a plurality of modules used in an Information System application.

### 1. FIELD OF THE INVENTION

The present invention relates to an Information System (IS) application architecture comprising self-contained, stand alone modules that work together and automatically update each other for all business requirements across a department, business, or enterprise. The architecture is called Synchronized Applications with Individual Databases (SAID) and the technology and embodiments of the invention are called SAIDware. The unique feature of this technology is a network-based data communication, validation, and transfer system, known as the Harmonizer™, which is employed to interface the plurality of modules used in the IS. The Harmonizer™ also ties these modules to existing legacy application for updating purposes. It is also provided in different embodiments, for example as completely alone as a middleware product or as a retrofit to legacy systems without the modules.

### 2. RELATED ART

The prior art consists primarily of middleware systems that are expensive, invasive, complex, and labor intensive to manage. Systems described in the prior art generally comprise of networks that assign several functions to a central platform, to which are connected a plurality of components, each component having several functions, thereby creating a central platform with an unnecessarily complex architecture and a plurality of components that are difficult to build, maintain, repair, and upgrade. In most instances, an upgrade of one or more components requires an extensive, expensive, and formidable task of replacing the entire IS architecture.

In recent years, as network-based communication systems have become increasingly complex, the need for Enterprise Application Integration (EAI) has increased. In the case of EAI systems, middleware is necessary to provide the backbone for EAI within diverse network environments. Therefore, the essential role of the middleware described in prior art is to manage the interface between databases, applications or servers (hereinafter “network components”). This is done through building complex integration networks, which need to share information, usually performed through batching, as described in detail below.

An additional trend in prior art data management systems is Enterprise Resource Planning (ERP), representing a system that supports numerous applications within an organization's network. A successful ERP requires effective and timely sharing of information between individual applications and the central server. Examples in the prior art have not achieved this technical effectiveness.

U.S. patent application No. 20030037174 A1 by D. Lavin et al. describes a method, apparatus, and computer-readable medium, interfacing between middleware software and application software using a plug and socket approach, in which the application-specific services and resources are isolated onto the plug and middleware-specific components are isolated into the socket. The plug and socket communicate with each other through an interface. The socket communicates with middleware software through an application program interface, and the plug communicates with application software through an application program interface. Therefore, the plug is isolated from communicating with the middleware software, and the socket is isolated from communicating with the application software. The main disadvantage of this middleware is that it lacks the presence of the secondary data channel, and this system does not reduce the workload on the central database. Neither is this prior art system suitable to adapt legacy applications and databases to give them the capacity to update each other. These disadvantages described in prior art middleware have been overcome in the present invention, as described below.

### 3. SUMMARY OF THE INVENTION

The present invention is a unique network-based data communications, validation, and transfer system, known as the Harmonizer™, which is employed to interface existing network environments.

The Harmonizer™ of the present invention may be employed to interface a plurality of inow™ modules, as part of the inow™ Modular Information System, an innovative IS application architecture, which is covered in detail in a co-pending application, which is incorporated herein.

The Harmonizer™ of the present invention is also useful in tying the inow™ modules to existing legacy applications for updating purposes, and in one embodiment is available alone like any other middleware product, as a retrofit to existing legacy systems without the inowow™ modules. Therefore, the embodiment as a retrofit to legacy systems can facilitate legacy data sharing and synchronization across all languages and platforms, in a manner previously associated only with well-implemented prepackaged software suites. The unique feature of the present invention is that there are no known scalability issues with inow™ modules or the Harmonizer™ Retrofit innovations. With the unique architecture comprising stand-alone modules (covered separately in a co-pending application filed concurrently) and a data transfer system, the module only has to deal with its own internal functionality as the Harmonizer™ interface deals with all external considerations. In other words, the inow™ module can be programmed in a simpler, smaller, faster, and more manageable way than ERP or previous custom-designed applications with central databases.

The above retrofit package of the invention may be adapted for application to existing legacy applications and databases, giving them the capacity to update each other via the Harmonizer™ interface that acts as a secondary data path and creates efficiencies, lightening the load on the main production database and cutting its cost of operation.

The Harmonizer™ of the present invention acts as a data centric, inexpensive middleware device, said device being able to function without the need for programmers to invasively change the routing of data for integration and transformation purposes. Once installed, the resulting secondary data path can handle more and more tasks that lessen the load on the primary database, affording a larger production window and giving synchronized data views to users, who were previously working with older information that came from batch updates. The spaghetti nature of most enterprise systems and databases begs for a productivity tool, for example the Harmonizer™ of the present invention, to sort out data integration and quality problems one by one.

One object of the present invention is to reduce the database management overhead by reducing the man-hours and machine-hours spent.

The second object of the present invention is to improve data integration by providing communication between stand-alone silos, applications, and systems without having to use more expensive traditional middleware implementation.

The third object of the present invention is to increase the database availability by batching less and maximizing around the clock (24 hrs×7 days) availability.

The fourth object of the present invention is to improve database performance with a secondary data path to lighten load demands.

The fifth object of the present invention is to provide data synchronization with real-time updates of data, reducing data lag in logically or physically separated environments.

The sixth object of the present invention is to improve data quality by updating the modules as data is generated by transaction in other modules by a shortened path, thereby not having to deal with batch updates, data lag, or corruption issues and validating the data by the Harmonizer™.

The seventh object of the present invention is to provide data warehouses and marts with improved decision support capability with near real-time, fresh data and metadata.

The eight object of the present invention is to provide a more cost-effective database license fee structure by trimming new license and upgrade requirements through reducing server size and the number of processor-based pricing schemes.

The ninth object of the present invention is to improve an organization's IS support through demonstrating the power of instant upgrades in every department and ensuring an adequate budget for IS through the support of managers and users.

### 4. BRIEF DESCRIPTION OF THE FIGURES

FIG. 1 represents the network-based information system architecture application and the Harmonizer™ Retrofit package.

FIG. 2 represents the prior art spaghetti nature of systems and databases that would greatly benefit from adding the Harmonizer™ Retrofit of the present invention as a simple middleware productivity tool.

### 5. DETAILED DESCRIPTION OF THE INVENTION

The present invention is a unique network-based data communications, validation and transfer system, known as the Harmonizer™, that is employed to interface existing network components. The Harmonizer™ of the present invention may be employed to interface a plurality of inow™ modular Information Architecture, covered in detail in a co-pending application, and incorporated herein in its entirety.

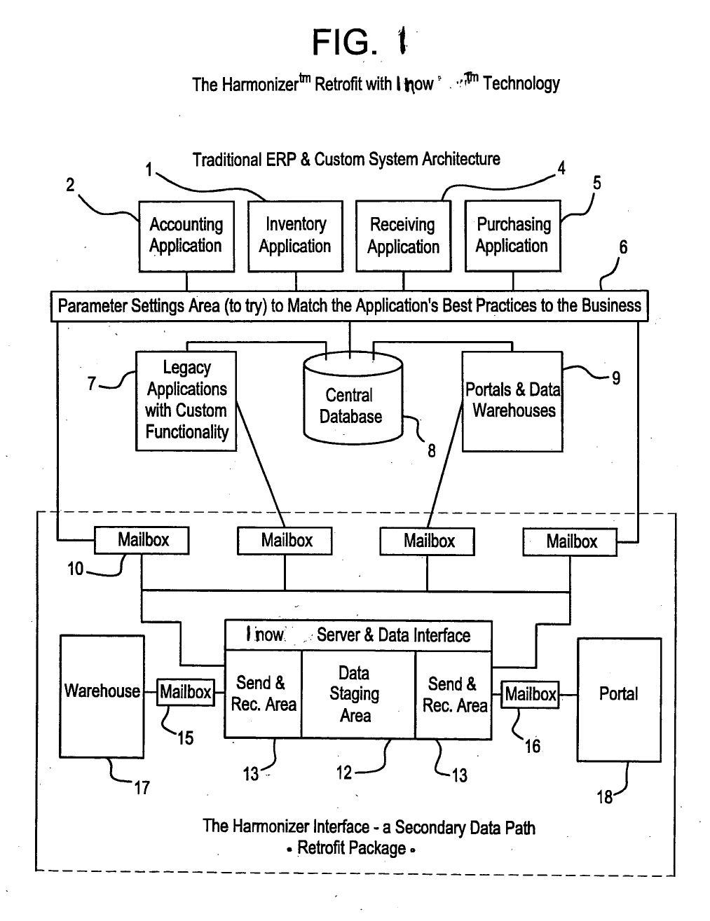

FIG. 1 describes a traditional ERP and a custom system architecture that includes the inventory application (1), the accounting application (2), the receiving application (4), the purchasing application (5), parameter settings are to try to match the applications best practices to the business (6), legacy application with custom functionality (7), a central database (8) and portals and data warehouses (9). Modules 1,2,4,and 5 have communication between them via a plurality of mailboxes. A receiving and sending area (13) is located on each side of the data staging area (12). The staging area (12) opens the record and sets up appropriate tables. The sending and receiving area (13) forwards the new message to the warehouse (17) via mailbox 15 to sending and receiving area (12) send the message to the portal (18) via mailbox 16. The Harmonizer™ technology dealing with the SAIDware is subject of a co-pending application by the inventors, entitled “Information System Comprised of Synchronized Applications with individual Data bases for implementing and Changing Business Requirements to be Automated” (serial number not yet assigned, but the co-pending application is being incorporated by reference in its entirely herein). The Harmonizer™ Interface ties the inow™ modules to existing legacy application for updating purposes. The architecture of the legacy application is called Synchronized Applications with Individual Databases (SAID) and the technology and embodiments of the invention are called SAIDware. The The unique feature of this technology is a network-based data communication, validation, and transfer system, known as the Harmonizer™, which is employed to interface the plurality of modules used in the IS. The Harmonizer™ also ties these modules to existing legacy application for updating purposes.

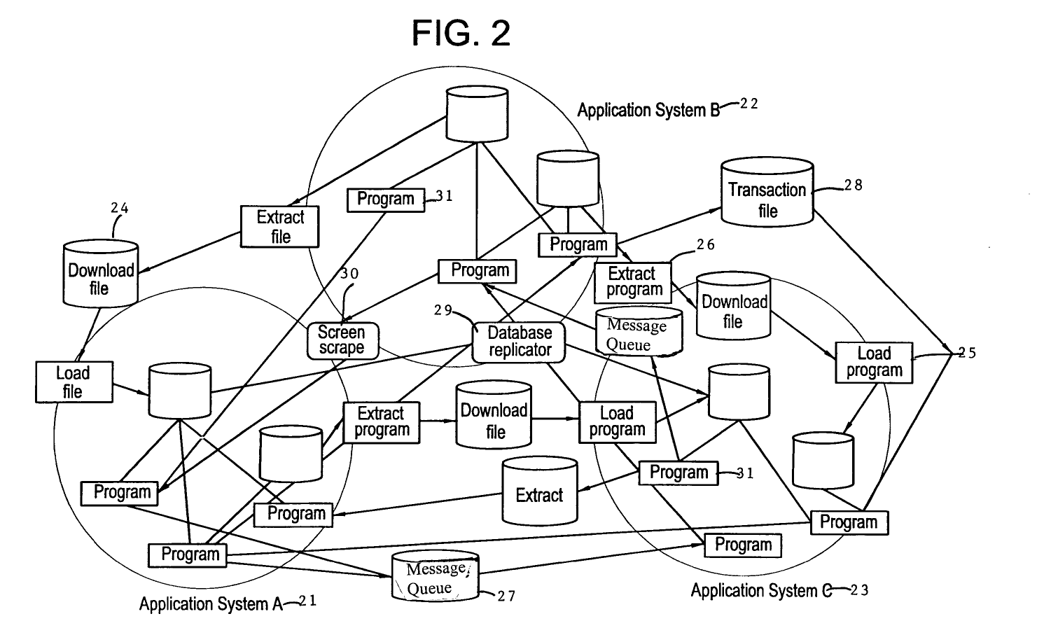

FIG. 2 describes the FIG. 2 represents the prior art spaghetti nature of systems and databases. Three application systems (21), (22), or (23) comprise the following elements: the download file (24), the load program (25), the extract program (26), the message queue (27), the transaction file (28), the database replicator (29) a screen scrape (30) and a plurality of programs (31).

The Invention is a data transfer, communication and validation system designed so that it can be added to existing network environments, capable of handling communication between various network components. Once added to an existing network environment the present invention performs the functions of traditional middleware, absent middleware's inherent shortcomings, which include expensive installation and maintenance. Also, the invasive nature of traditional middleware is not present in the present invention. Middleware is commonly referred to as invasive because of the extensive re-engineering of a network that must be done during its installation. In addition, traditional middleware requires code to be written into the central database to accommodate the routing of data. As such, the majority of the work has to be done by professional programmers.

A further advantage of the present invention is that, almost exclusively, data entry professionals can administer it, as the installation process does not require extensive rerouting. Also, removing traditional middleware from a network is laborious and frequently causes damage to the operation of a system or loss of data. Neither of these problems arises in the installation or removing of the Invention from the network.

A further advantage of the present invention is that it increases database availability by decreasing batch updates. When systems commonly used today update data by batching the availability of the database is reduced substantially. As a result system user may experience slow response times or a completely unavailable system. The present invention uses batches as a means to validate the transfer of data. Periodic batch confirmation can be scheduled so that it occurs at times when database activity is low, thereby only reducing availability at times when little is needed. The data synchronization technique utilized by the Invention possesses two distinct advantages over the art. First, data is synchronized as soon as it is made available. Second, data confirmation occurs only at times when database activity is low.

Communication between network components occurs in the following manner in the preferred embodiment. A transaction manually entered into a given module is sent via an individual mailbox to a receiving area. The receiving area forwards the message to the central staging area, which in turn opens the record and the appropriate tables. A device then performs the operations that are required by the other modules. The appropriate information is then sent, via a sending area, to the mailbox of the respective recipients. The result is each module receives the information it needs, and no irrelevant information, without placing an unnecessary workload on the central database.

The above-described method of transferring data outside of the core functionality of any particular network component benefits the individual network component. The resulting network components are written with one less function, the routing of data, to handle and are therefore easier to maintain and less prone to complications arising from conflicting code.

The presence of a second data path serves the function of lessening the workload on the central server. The second data path allows data to be transferred from any network component to any other network component, thereby reducing the workload of the central database. In reducing the workload of the central database the Invention increases the availability thereof, for various users including among them, internet users.

In summary, the present invention provides a system that improves:
Database management overhead by reducing both man-hours and machine-hours.
Data integration through enhancing communication between stand-alone silos, applications, and systems without the need for more expensive middleware implementations.
Data performance through the presence of a secondary data path, which lightens load demands.
Data synchronization with real-time updates of data views and reducing data lag in logically or physically separated environments.
Data quality by updating modules as data is generated by transactions in other modules and validated by the Harmonizer™.
Data warehouses and marts by providing them better decision support capabilities with near real-time fresh and metadata.
Data license fees by trimming new license and upgrade requirements.
Overall support from management by exhibiting the power of instant updates in every department.

While the above description contains many specifics, these specifics should not be construed as limitations on the scope of the invention, but merely as exemplifications of preferred embodiments thereof. Those skilled in the art will envision many other possible variations of the described embodiments of the present invention.

1. A system for transferring, synchronizing and validating data, said system comprising a middleware product capable of connecting to a legacy system.

2. The system according to claim 1, further comprising means for interfacing a plurality of modules in a network environment.

3. The system according to claim 1, further comprising a secondary data channel to transmit data between application, modules or silos without passing through the central database.

4. The system according to claim 1, wherein the modules may be added to perform specific business activities selected from the group consisting of accounting, purchasing, receiving, engineering, inventory and manufacturing.

5. The system according to claim 4, further comprising a customer interface screen to meet specific needs of the customer.

6. A method for transferring, synchronizing and validating data, said method comprising the steps of:
entering data in a first module,
forward said data via the first module mailbox to a receiving area,
forwarding said data from the receiving area to a data staging area,
setting up appropriate tables in the staging area using a device that performs necessary operations,
making the code used by one module readable to other modules,
selecting the appropriate data to insert in the charts,
forwarding the tables from the staging area to a second sending area and via a second set of mail boxes to the modules, and validating the data.

7. The method according to claim 6, wherein the validation steps comprise:
scheduling times for batch validation based on historical patterns of systems used,
entering data contemporaneously to previous batch validation and prior to current validation.
